(19) United States
(12) Patent Application Publication
(10) Pub. No.: US 2006/0238337 A1
(43) Pub. Date: Oct. 26, 2006

(54) Security system with remote control and proximity detector

(75) Inventors: Minas Minassian, Vista, CA (US); Franklin Ochs, Vista, CA (US); Jerry Wayne Birchfield, Vista, CA (US)

Correspondence Address: Directed Electronics, One Viper Way, Vista, CA, 92081, US

(73) Assignee: DEI HEADQUARTERS, INC., Vista, CA (US)

(21) Appl. No.: 11/110,135

(22) Filed: Apr. 20, 2005

(51) Int. Cl. G08B 1/08

(52) U.S. Cl. 340/539.23; 340/426.26

(57) ABSTRACT

A security system provides interaction between the system's remote control (RC) device and field disturbance sensor/proximity detector. In selected embodiments, the system enables a user to adjust the detector's sensitivity through the RC device. The user puts the system in a programming mode and creates simulated security breach events. The system stores detector output corresponding to the events, and sets the detector's sensitivity based on the stored output. In embodiments, the system includes passive remote capability that automatically performs commands when a user approaches its base station. The base station uses output of the proximity detector to sense a person's movement near the base station, and sends an interrogatory transmission to the RC device. If the device is nearby, it responds to allow the base station to verify the device's identity. After the base station verifies identity of the device, it disarms the security system and unlocks the automobile doors.

### FIELD OF THE INVENTION

The present invention relates generally to security, alarm, and convenience systems, and, more particularly, to remotely controlled vehicular and other security systems equipped with proximity detectors.

### BACKGROUND

Security and alarm systems are known. A security system may be used to secure a perimeter or an object against theft, tampering, vandalism, invasion, unauthorized use or access, and other kinds of trespass. The secured object or perimeter may be, for example, a vehicle or a building, protected by sensors capable of detecting glass-break events; proximity or movement of a person; openings of doors, trunk, or hood; and other potential breaches of security. A typical security system designed for automotive applications is capable of responding to breaches of security, for example, by activating an alarm and rendering engine starter and engine computer systems inoperative. In addition, some security systems can control various safety and convenience features, such as power door locks, power windows, and entertainment system installed in the vehicle.

Many automotive security systems include a small hand-held remote control device, such as a key-fob, that allows the system's user to perform various operations remotely. For example, the remote control device may arm and disarm the security system, lock and unlock doors and trunk, sound siren, start engine, and perform other functions when corresponding commands are entered by the user. If the security system is configured so that the remote control device can be used to lock and unlock doors of an automobile, the system effectively becomes a keyless entry device, in addition to performing other functions.

It is known in the art to automate the keyless entry function of a remote control device. For example, a hand-held remote control device may be configured to transmit periodically a command that disarms the security system and unlocks doors. It may also be the base station that periodically transmits a “feeler” or interrogatory transmission to the hand-held remote control device. When the remote control device receives the interrogatory transmission, it sends a responsive transmission to the base station. The base station and the hand-held device then perform a handshake protocol to verify each other's identity. After the handshake, the hand-held unit may transmit a command directing the base station to perform some function automatically, for example, to unlock one or more doors of an automobile. The doors then automatically unlock when the user carrying the hand-held device approaches the automobile. The feature of automatically unlocking doors when a user approaches the automobile is known as “passive” remote keyless entry or “passive” remote control. The system is passive in the sense that it disarms itself and unlocks doors without any deliberate user action, other than approaching the automobile.

Generally, it is desirable to unlock automobile doors automatically only when the user is in the immediate vicinity of the automobile, but not when the user is relatively far from the automobile. Automatically disarming the security system and unlocking the doors and when the user cannot see the automobile leaves the automobile unprotected and vulnerable before the user can prevent unauthorized access. Even worse, accidental unlocking of the doors after the user has locked the doors and walked away may leave the automobile unprotected for a prolonged period. Moreover, a user may be annoyed by constant arming and disarming of the security system and locking and unlocking of doors when the automobile is parked in the driveway or garage of the user's home and the remote control device is stored in a safe place. Therefore, it may be desirable to decrease the range of passive (automatically transmitted) commands.

One way to limit the range of the passive commands is to reduce the power of the interrogatory transmissions, so that the remote control device functions only within a relatively close range of its base station. Such range reduction, however, would adversely affect the robustness and reliability of the transmissions because of potential obstacles in the signal path, multi-path effects, noise, and battery discharge in the receiving hand-held unit.

It would be advantageous to avoid the drawbacks of known systems while preserving robustness of communications between the base station and the remote control device.

Because of individual preferences, manufacturing tolerances, and varying environmental and operational conditions, some security system detectors are designed to allow sensitivity adjustments. Without adjustability, an overly-sensitive proximity detector, for example, may trigger a nuisance alarm when another vehicle is parked next to the automobile equipped with the security system, or when people walk by the automobile in a parking lot. On the other extreme, a proximity detector with inadequate sensitivity may not activate the alarm until an intruder is in the driver's seat of the automobile. Moreover, individual preferences regarding sensitivity settings differ from user to user, and over time, and security system components may age, changing the detector sensitivity from its preset level. All these considerations encourage engineers to build detectors with variable and adjustable sensitivity settings.

In many conventional security systems, calibration (adjustment) of the proximity detector needs to be performed in a factory or at a dealer/installer facility. One reason for this necessity is that calibration of a proximity detector typically requires access to the base station of the security system. For example, a potentiometer may have to be rotated in order to change the detector's sensitivity. In this case, calibration may be a multi-step, back-and-forth process of adjusting the detector's sensitivity, testing the sensitivity, and then adjusting it again, until the desired level of sensitivity is achieved. Accessing the base station and performing the multi-step calibration process at a dealer or installer facility is inconvenient, and may involve substantial expense.

Other security systems allow the sensitivity adjustment to be performed by the end-user, and do not require the user to access the base station of the security system. For example, a security system may be configured to have a proximity detector calibration mode in which certain commands from the hand-held unit cause the security system to increase or decrease detector sensitivity in steps. Such feature (among other features) is described in Drori, U.S. Pat. No. 6,028,505. This commonly-assigned patent is incorporated by reference herein in its entirety, including all figures, tables, and claims.

In some circumstances, however, it may be preferable to have continuously or finely adjustable sensitivity of a proximity detector, rather than sensitivity adjustable in discrete steps. It may also be preferable to enable the end-user to adjust calibration of a proximity detector without resorting to an iterative process whereby the user selects a sensitivity setting, tests operation of the detector with the selected setting, steps up or down to another setting, and then repeats the procedure as needed.

### SUMMARY

A need thus exists to facilitate calibration of a security system's proximity detector in accordance with preference of the system's end-user. Another need exists for providing security systems with proximity detector sensitivity infinitely adjustable by the end-user. Still another need exists for preserving transmission range and robustness of base station transmissions to a hand-held remote control device, while limiting the range of passive remote control and/or security commands in a security system.

Embodiments of the present invention are directed to methods, apparatus, and articles of manufacture that satisfy one or more of these needs. In some aspects, the invention herein disclosed is a method of adjusting sensitivity of a proximity detector in a security system with a remote control device, including the following steps: (1) monitoring the detector to detect a simulated security breach event, (2) receiving an indication (e.g., a transmission) from the remote control device signaling that the event has occurred, and (3) setting the sensitivity of the detector based on output of the detector corresponding to the event. The method may further include a step of (4) identifying the simulated event from the output of the detector immediately preceding receipt of the indication.

The step of setting may include adjusting the sensitivity so that the detector is capable of responding to future security breach events substantially identical to the event, and/or only with severity substantially no less than severity of the event.

In selected aspects, the method further includes measuring a metric (i.e., a standard of measurement) corresponding to the event within the output to obtain a first value. The step of setting may include setting a threshold for the output metric of the detector to a number substantially equal to the value. After the step of setting, the security system is capable of generating an alarm when the output metric violates the threshold. The metric may be signal amplitude, signal frequency, or another metric.

In selected aspects, the proximity detector emits RF waves, detects movement in the RF field, and measures characteristics of the movement. The power level emitted by the RF transmitter of the proximity detector can be adjusted and/or the gain of the amplifiers can be adjusted to set the detector's sensitivity.

In some aspects, the invention herein disclosed is a method of adjusting sensitivity of a proximity detector in a security system with a remote control device, including the following steps: (1) monitoring the detector to detect a plurality of simulated security breach events, (2) receiving indications from the remote control device (e.g., transmissions from the remote control device), each received indication signaling that an event from the plurality of events has occurred, and (3) setting the sensitivity of the detector based on output of the detector corresponding to the events. The method may further include a step of (4) identifying each of the simulated events from the output of the detector immediately preceding receipt of one of the indications.

In selected aspects, the method further includes measuring a metric corresponding to the events within the output to obtain a plurality of values, each value of the plurality of values corresponding to a different one of the events. In setting the sensitivity of the detector, threshold for the output metric of the detector may be set to a number substantially equal to average of all or at least a subset of the plurality of values. In one aspect, the security system is capable of generating an alarm when the output metric violates the threshold, after the step of setting. The metric may be (or be determined by) signal amplitude, frequency, or another metric.

In some aspects, the invention herein disclosed is a method for operating a base station of a security system, including (1) monitoring output of a proximity detector of the security system, and (2) sending an interrogatory transmission (used for passive remote control) to a remote control device of the security system in response to an event detected by the proximity detector. The method may further include steps of (3) receiving a response to the interrogatory transmission, (4) determining whether the response was sent by a remote control device authorized to control the security system, and (5) passively performing at least one command by the base station in response to the step of determining resulting in a determination that the response was sent by a remote control device authorized to control the security system.

In selected aspects, interrogatory transmissions are sent only in response to events detected by the proximity detector.

In selected aspects, the at least one command includes a command to disarm the vehicle's security system, a command to unlock one or more doors of a vehicle, and/or a command to start the vehicle's engine.

Embodiments of the invention further include memories and other machine-readable articles of manufacture with program code embedded therein. The code, when executed by a processor of a security system base station, configures the base station to perform as described above. Embodiments of the invention further include security systems and base stations that perform as described above.

These and other features and aspects of the present invention will be better understood with reference to the following description, drawings, and appended claims.

### BRIEF DESCRIPTION OF THE FIGURES

FIG. 1 illustrates selected steps of a process for adjusting sensitivity of a proximity detector of an automotive security system, in accordance with an embodiment of the present invention;

FIG. 2 is a high-level block diagram of a security system, in accordance with an embodiment of the present invention;

FIG. 3 is a high-level block diagram of the remote control device of the security system of FIG. 2; and

FIG. 4 illustrates selected steps of a process implementing passive remote capability enhanced through the use of a security system proximity detector.

### DETAILED DESCRIPTION

In this document, including the appended claims, the words “embodiment” and “variant,” as well as similar expressions, refer to particular apparatus, process, or article of manufacture, and not necessarily to the same apparatus, process, or article of manufacture. Thus, “one embodiment” or a similar expression used in one place or context may refer to a particular apparatus, process, or article of manufacture; the same or a similar expression in a different place may refer to a different apparatus, process, or article of manufacture. The expressions “alternative embodiment,” “alternatively,” and similar phrases are used to indicate one of a number of different possible embodiments. The number of potential embodiments is not necessarily limited to two or any other quantity. The words “couple,” “connect,” and similar expressions with their inflectional morphemes do not necessarily import an immediate or direct connection, but include connections through mediate elements within their meaning. To “violate” a threshold means to fall above the threshold if the threshold is an upper threshold; the same word refers to falling below the threshold when the threshold is a lower threshold. Thus, a field disturbance sensor/proximity detector's signal metric that tends to increase when a person approaches a zone protected by the detector violates an alarm threshold when it exceeds the threshold; a proximity detector's signal metric that tends to decrease when a person approaches a protected zone violates an alarm threshold when it falls below the threshold. “Radio frequency” or “RF” are used to describe the portion of the electromagnetic spectrum that includes microwaves, extending from about 10 KHz to about 300 GHz. The expressions “feeler” and “interrogatory transmission” refer to initial transmissions made by a security system base station to the system's remote control device, or vice versa, for implementing passive remote entry functionality. After the intended recipient of the transmission (the remote control device or the base station) receives the interrogatory transmission, it responds and the two units perform a handshake to verify each other's identity, for example. The remote control device may then automatically send to the base station a command to disarm the security system, unlock doors, or start the engine. The base station may also perform such command(s) without the remote control device sending the command(s). Other definitions may be found elsewhere in this document. The scope and spirit of the invention should not be construed as strictly limited to these definitions, or to the specific examples mentioned herein.

The invention herein disclosed can be implemented as part or feature of a security system such as systems described in the following patent documents:

U.S. patent application entitled MENU-DRIVEN REMOTE CONTROL TRANSMITTER, filed on Oct. 30, 2003, application Ser. No. 10/699,009;

U.S. provisional patent application entitled SECURITY AND REMOTE ACCESS FOR VEHICULAR ENTERTAINMENT, SAFETY, AND CONVENIENCE SYSTEMS, filed on Jan. 2, 2004, application Ser. No. 60/533,942; and

U.S. patent Ser. No. 6,700,479.

Each of these commonly-assigned applications and patent is incorporated by reference herein in its entirety, including all figures, tables, and claims.

Reference will now be made in detail to several embodiments of the invention that are illustrated in the accompanying drawings. Same or similar reference numerals may be used in the drawings and the description to refer to the same or like apparatus elements and method steps. The drawings are in simplified form, not to scale, and omit apparatus elements and method steps that can be added to the described systems and methods, while including certain optional elements and steps.

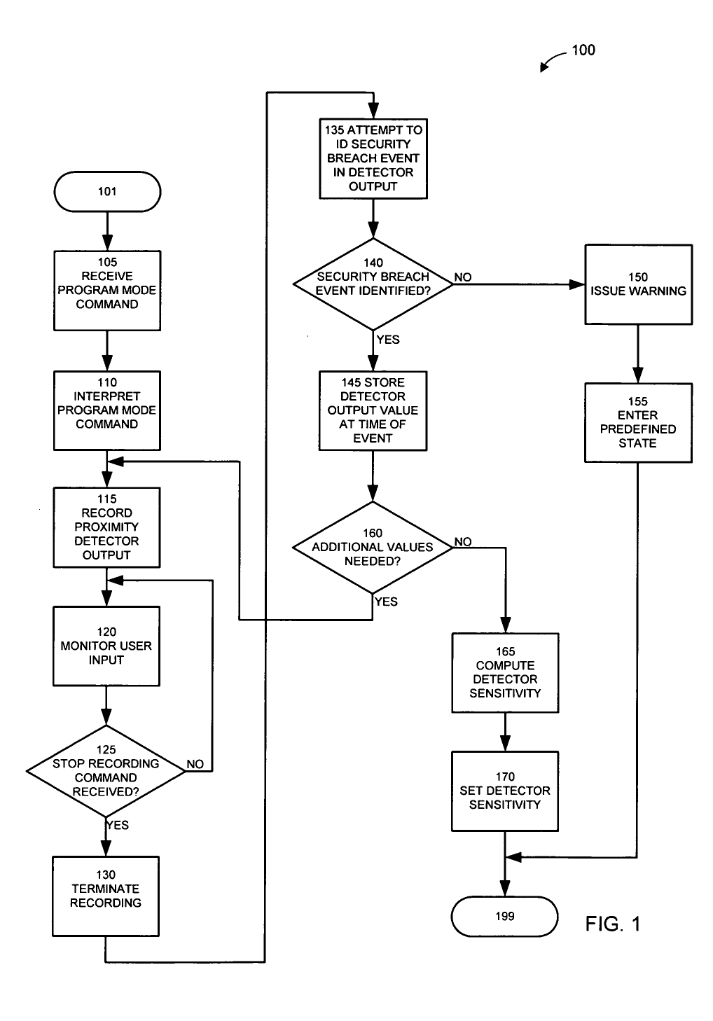

FIG. 1 is a process flow diagram illustrating selected steps of a process 100 for adjusting sensitivity of a proximity detector of an automotive security system. Although certain steps are described serially, some of these steps can be performed by separate elements in conjunction or in parallel, asynchronously or synchronously, in a pipelined manner, or otherwise. There is no particular requirement that the steps be performed in the same order in which this description lists them, except where explicitly so indicated, otherwise made clear from the context, or inherently required. Furthermore, not every illustrated step is required in every embodiment in accordance with the invention, while some steps that have not been specifically illustrated may be desirable or necessary in some embodiments in accordance with the invention.

At flow point 101, the security system is operational and ready to perform the steps of the process 100.

At step 105, the security system receives a command or code directing the system to enter a programming mode in which the proximity detector sensitivity is adjusted. The user may enter the command or code in several different ways. In one embodiment, the user depresses a key or enters a key sequence via the hand-held device of the security system. In response to the key sequence, the hand-held device transmits the command to the base station, which enters the programming mode when it receives the command. In another variant, the user enters the command through a numerical or alphanumerical keypad installed in the automobile and connected to the base station. In one embodiment, the user sets one or more switches, for example, dip switches, to a known configuration, causing the base station to enter the programming mode. In yet another embodiment, the user manipulates one or more alarm zones and/or valet switch of the security system in a controlled way to cause the base station to enter the programming mode. For example, the user may be able to enter the command by depressing the valet switch and opening and closing driver side front door. The security system may be able to enter the programming mode using multiple techniques described above, as well as other programming techniques known to a person skilled in the art at this time, or that will become known in the future.

The user may be required to enter a password or a personal identification number (PIN), or to provide biometric authentication before being allowed to adjust the detector sensitivity or program other features of the security system.

At step 110, the security system interprets the command received from the user and enters the programming mode, i.e., mode in which the sensitivity of the proximity detector is adjusted.

At step 115, the security system begins to record output of the proximity detector. For example, the security system begins to record the voltage output by the proximity detector. Recording may continue for a predetermined period or until it is terminated by the user at a later step. The recording may also be performed on an endless loop basis, so that at any point in time, at most a predetermined period immediately preceding that point is recorded. The latter approach avoids recording detector output that is too remote in time to be useful in programming the sensitivity, and consumes known memory resources.

Recording may be performed using analog techniques or digital sampling.

At step 120, the security system begins (or continues) to monitor input from the user. The input that it awaits is an indication to stop recording the output of the proximity detector. The user may send this indication in several ways, for example, as described above in relation to the step 105. In one embodiment, the user sends the stop recording indication by pressing a designated key or entering a specific key sequence at the hand-held remote control device, which sends a stop recording command to the base station. As will be seen at a later point in this document, the user sends the indication to stop recording after the user has created a sample “security breach event” to be used in adjusting the detector's sensitivity.

At decision block 125, the security system determines whether the stop recording command has been received. If the stop recording command has not been received, process flow returns to the step 120. Thus, the step 120 and the decision block 125 form a loop from which the process flow exits upon receipt of the stop recording command.

In some embodiments, a timer is incorporated into this loop so that process flow may exit from the loop upon expiration of a predetermined time period, even if the security system does not receive a stop recording indication. For example, the security system may exit the loop and enter into a predefined default state upon expiration of the timer. In one embodiment, the security system enters an armed state when the timer expires. In a variant of this embodiment, the security system produces an audio and/or visual indication upon expiration of the timer, alerting the user that the detector adjustment process has not been completed. The audio indication may be, for example, a siren chirp, while the visual indication may be flickering of a light emitting diode (LED). In another embodiment, the security system reverts to the state in which it was when it received the command or code directing the system to enter the programming mode, i.e., the state in which the system was at the time of the step 105.

If the security system determines at the decision block 125 that the stop recording command has been received, process flow advances to step 130 to terminate the recording. At this point, a history of the detector output over an immediately preceding period has been accumulated in the memory of the security system. Note that some lag may be present between the point when the stop recording command is received and the point when the recording is stopped. In some embodiments, the lag is artificially lengthened so that a more complete waveform of the detector output is captured by the security system. In other embodiments, however, a predetermined period immediately prior to the receipt of the stop recording command is deleted, so that the system ignores the portion of the waveform that might have been affected by the user's movement when issuing the stop recording command.

At step 135, the security system attempts to identify the level of the proximity detector signal corresponding to the security breach event that took place. For example, the identified level may be the highest magnitude of the detected signal during the period, the amplitude of the detected signal integrated over a predetermined period of time, the highest Doppler shift frequency during a period of time, or some derivative of these or other metrics. If the security system successfully identifies the level of the detector signal corresponding to the security breach event, as determined in decision block 140, the system stores the measurement of this level in step 145.

It may also happen that the system is unable to identify reliably a security breach event during the period. For example, the amplitude of the signal may remain below some predefined threshold during the period. In this case, the system proceeds to step 150 to issue an audible or visual warning, and enters a predefined state, at step 155. For example, the system may then enter a default armed state, or revert back to the state in which the system was at the time when it received the command or code directing the system to enter the programming mode. Process flow then terminates at flow point 199.

In one alternative embodiment, the system returns to the step 115, instead of entering the predefined state in the step 155. (This is not illustrated in FIG. 1.) The process flow continues from that point as has already been described.

After measurement of the proximity detector output corresponding to an event is stored in the step 145, process flow proceeds to decision block 160 to determine if additional one or more measurements should be stored. For example, the system may require or allow the user to perform sensitivity adjustment using two or more attempts. If so, the system may offer the user a choice of continuing to accumulate the stored event measurements, or to proceed to adjust the sensitivity of the proximity detector based on the measurement or measurements already stored by the system. Alternatively, the system may ensure that a predefined number of measurements have already been stored at the step 145. In the latter case, the system may zero a counter as part of the step 110, and increment the counter every time a level measurement is stored in the step 145.

If additional measurements are needed, process flow returns to the step 115 and proceeds from that point as has been described above.

If a sufficient number of detector output measurements corresponding to security breach events has been accumulated, the security system advances to step 165 to compute a new detector sensitivity setting based on the stored measurement or measurements. At step 170, the security system adjusts the operation of the proximity detector to make the new sensitivity setting effective.

Computing the new setting and adjusting the operation of the proximity detector may be done in a variety of ways, and the invention is not necessarily limited to any one of them. In some embodiments, the operation of the detector is adjusted so that the detector will trigger a response (e.g., trigger an alarm or warn-away response) in case of future events similar to the security breach event that took place during the adjustment process. At the same time, the adjustment is such that the detector is not likely to trigger a response in case of future events with severity slightly lower than severity of the security breach event that took place during the adjustment process. In other words, the detector is adjusted within engineering and practical limits to triggers a response only to future security breach events with severity equal to or greater than the severity of the event that took place during the adjustment process.

It should be noted that “severity” of a security breach is a function of a metric that is related to the decision whether an alarm, warn-away, or a similar response is warranted. The closer the metric comes an alarm threshold, the greater the severity of the breach. Similarly, the greater the degree with which the metric violates the threshold, the greater the severity of the breach. For example, if the proximity detector outputs a voltage that increases with proximity of an intruder to the detector and with the size of the intruder, then severity increases along with the voltage output by the detector.

In some embodiments, the proximity detector generates an analog or digital output representing, for example, amplitude, frequency, or another signal metric. In normal operation, the output is compared to a threshold to determine whether an alarm or a similar event should be generated (e.g., alarm reported to the user, warn-away sounded, siren activated). In these embodiments, the threshold may be computed from the measurement or measurements stored. For example, the threshold may be set equal to the stored measurement in case of a single measurement stored in the step 145, or to an average or median of the stored measurements in case two or more measurements have been stored. The average of multiple measurements may be computed after discarding the lowest and highest stored measurements, and the average may be adjusted up or down, depending on additional considerations. In one embodiment, the system computes the new threshold so as to minimize the root-mean-square of the differences between the new threshold and the stored measurements. Other statistical tools may also be used in computing the threshold.

In the step 170, the system makes the new threshold effective. For example, the system stores the new threshold in an appropriate memory location.

In one embodiment, the proximity detector emits radio frequency radiation and measures amplitude and Doppler shift of reflected signals. The alarm threshold in this embodiment remains constant. Instead of adjusting a threshold applicable to the detector output, the system varies the RF power output of the detector's RF transmitter to adjust the detector sensitivity. To compute the new detector setting in the step 165, a processor of the security system computes a hypothetical threshold, for example, as has been described in the preceding paragraphs. The computed threshold is then compared to the actual (constant) threshold, and the new setting for the emitted RF power is computed from the difference between the two thresholds and a relationship between the transmitted power and the signal observed at the proximity detector's output. The relationship between the transmitted power and the observed output may be stored, for example, in one or more tables, one table per reflection coefficient. If the difference between the computed threshold and the actual threshold indicates that the transmitted power should be decreased by three decibels, for example, the detector's transmitter or output amplifier is adjusted to half the transmitted power.

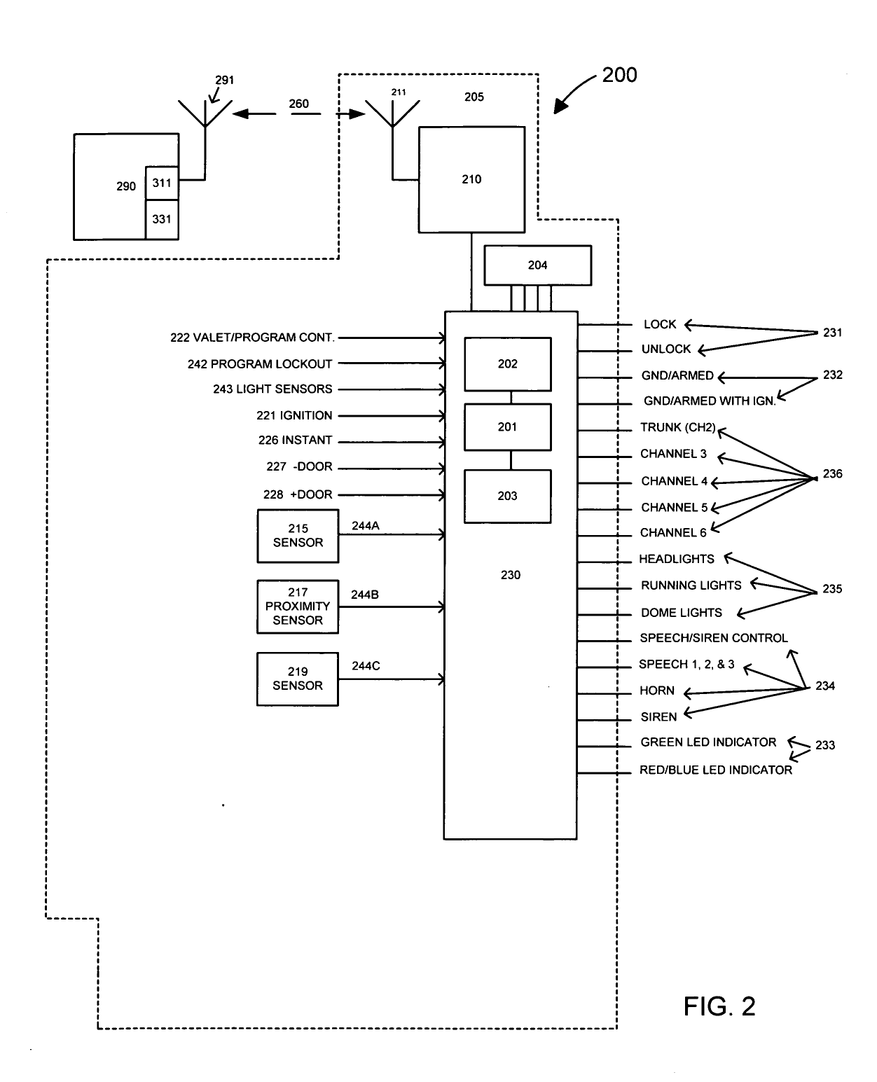

FIG. 2 is a simplified schematic diagram of a vehicle security system 200 that can perform the steps of processes described in this document. As illustrated, the system incorporates a remote control device 290, a wireless link 260, and base station 205 that includes the remaining components shown in FIG. 2 (appearing within the dotted lines). The remote control device 290 includes an antenna 291, transceiver 311, and controller 331.

The base station 205 includes a base controller 230; a base transceiver 210 with its antenna 211; sensors/detectors 215, 217, and 219; and various inputs and outputs. The base controller 230 includes a processing unit 201, a non-volatile instruction memory 202, and operation memory 203. In the described embodiment, the base controller 230 is implemented as a microprocessor 201 with internal memory modules 202 (ROM) and 203 (RAM). As illustrated in FIG. 2, an external non-volatile memory device 204, such as an electrically erasable programmable read-only memory (EEPROM), can supplement the microprocessor memory, storing, for example, field-configurable control data and remote controller codes.

The base transceiver 210 communicates with the remote control device 290 over the RF link 260. Thus, the base controller 230, which is coupled to the transceiver 210, can communicate with the remote control device 290 through the base transceiver 210 and the RF link 260. Although in the described embodiment the link 260 is shown as a bi-directional link, in some alternative embodiments the link 260 is unidirectional, carrying commands from the remote control device 290 to the base controller 230, but not in the opposite direction; in such embodiments, a simple receiver can perform the necessary functions in place of the transceiver 210.

The sensors/detectors of the described device 205 include a shock detector 215, a proximity detector 217, and a glass break detector 219. Any other detectors appropriate to an automotive security system (or another installed environment) can be included as well.

As has been mentioned above, the proximity detector 217 is an RF detector. In other embodiments, the proximity detector 217 is an infrared (IR) detector or an ultrasound detector. Other proximity detector technologies can also be used consistent with the present invention. Communication between the proximity detector 217 and the base controller 230 may be unidirectional as is shown in FIG. 2. In this embodiment, the base controller 230 receives the proximity detector signal and compares the signal to the alarm threshold stored in one of the memories 202, 203, or 204. In some alternative embodiments, communications between the proximity detector 217 and the base controller 230 are bidirectional. For example, the base controller 230 may be able to set the alarm threshold in the proximity detector 217, to set the RF power level emitted by the detector 217, or to put the detector 217 into a self-test or calibration mode.

Among the additional inputs to the base station 205 are these: +/−door inputs 228 and 227; a light detector input 243; a valet/program control switch input 222; an ignition input 221; and a program lockout input 242, intended to prevent both accidental and intentional (subversive) programming of the base station 205, and programming of the remote control device 290 through the base station 205.

Lines 231 through 236 provide the following signal and control outputs:

Power door lock and unlock outputs—231;

Ground when armed and ground when armed-plus-ignition outputs for starter interrupt—232;

LED indicator outputs—233;

Speech, horn, and siren outputs for audible alarms and warnings—234;

Headlights, running lights, and dome light outputs—235; and

Channels 2 (trunk), 3, 4, 5, and 6 auxiliary outputs—236.

The code of the program executed by the base controller 230 is normally embedded at the factory during the integrated circuit manufacturing process, but it can also be loaded or burned-in from a variety of sources in the field, for example, from a programming tool, machine-readable medium, such as a CD, DVD, flash memory, floppy or hard drive, or a similar memory or storage device. The code may also be loaded into the base controller 230 via a network, such as the Internet.

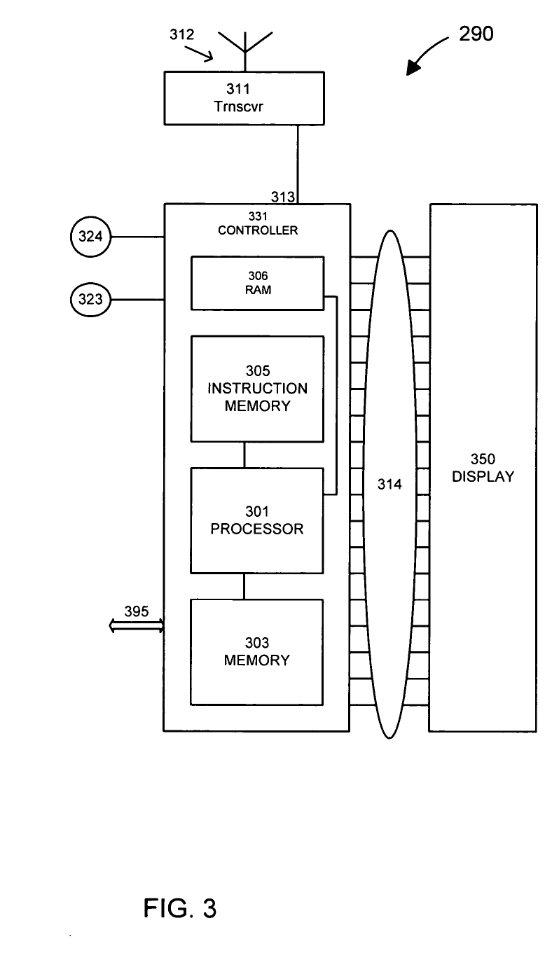

FIG. 3 illustrates a simplified block diagram of an embodiment of the remote control device 290 built on the platform of a controller 331, which can be, for example, a microcontroller (MCU), a microprocessor, or an application-specific integrated circuit. In the specific embodiment of FIG. 3, the controller 331 is a microcontroller. It includes a processing unit 301; random access memory 306 for use as operating registers, address registers, and for other data storage during program execution; and memory modules 303 and 305 for storing program instructions and data. The memory modules 303 and 305 can be, for example, read only memories (ROMs), programmable ROMs (PROMs), electrically programmable ROMs (EPROMs), and electrically erasable PROMs (EEPROMS). The memory module 305 is typically used to store program instructions and constants. In the embodiment of FIG. 3, the memory module 303 is a non-volatile, re-writable memory module, such as Flash, EEPROM, or low-power battery-backed memory. It is used to store programmable control and configuration data, such as icon definitions and menu lists, for the functional routines of the remote control device 290.

The controller 331 also has an input-output (I/O) section that provides the controller 331 with capability to read inputs and drive outputs under program control. The inputs of the I/O section of the controller 331 include connections to user-operable inputs 323 and 324, such as a scroll switch, a selection switch, and a keypad. The outputs of the I/O section further include the outputs 314 for driving a display 350, and transceiver input/output lines 313 used to send data to and receive data from the base station 205 via the transceiver 311.

The display 350 is part of the user interface of the remote control device 290. It can be a graphical or an alphanumeric display.

The transceiver 311 can accept data for transmission to the transceiver 210 of the base station 205. As mentioned previously, the link 260, over which the remote control device 290 and the transceiver 210 communicate, can be an RF, IR, ultrasound, or another kind of link. The nature of the link 260 dictates the specifics of the transceiver 311 and the transceiver 210.

The program code instructions executed by the controller 331 include instructions that prompt and enable the user of the remote control device to key-in commands that the controller 331 can interpret and, in response to the commands, cause the transceiver 311 to transmit corresponding signals to the base controller 230. Among the commands made available to the user are the commands that cause the base station 205 of the security system 200 to enter a programming mode in which the sensitivity of the proximity detector can be adjusted, and the stop recording command indication that causes the base station 205 to stop recording the output of the proximity detector, as has been described in relation to the steps 120/130 and the decision block 125 of FIG. 1.

The process 100 for adjusting proximity detector sensitivity is of course exemplary and not uniquely required for practice of the invention, as of course is the case with other process and apparatus embodiments described in this document. Many other variations on the described calibration techniques will surely occur to a person skilled in the art after perusal of this document.

The techniques for adjusting the alarm threshold described above may also be applied to adjusting the warn-away threshold of the security system. Warn-away is a feature of security systems that enables a system to respond to certain violations/breaches by warning the potential intruder away from the protected object or perimeter, without entering a full alarm mode. An automotive security system may respond to proximity sensor output that exceeds a warn-away threshold by sounding a warning, such as a series of chirps or a voice message, for example, “STEP AWAY FROM THE VEHICLE.” If the intruder does not comply, the security system may enter an alarm mode, for example, if the proximity sensor output exceeds an alarm threshold. Generally, the alarm threshold is higher than the warn-away threshold.

A security system may enable its user to adjust both the alarm threshold and the warn-away threshold. In one embodiment, the system provides the user with a choice of programming/adjusting either threshold after entering the programming mode. If the user chooses to program the alarm threshold, the security system configures the proximity detector to make the new alarm threshold effective. If the user chooses to program the warn-away threshold, the security system configures the proximity detector to make the new warn-away threshold effective.

The system may also ensure that the relationship between the two thresholds is such that warn-away warning is sounded before the system enters the alarm mode. For example, the security system may reject the user's attempt to enhance alarm sensitivity beyond that of warn-away sensitivity, and issue an appropriate annunciation advising the user that the process has not been successfully completed.

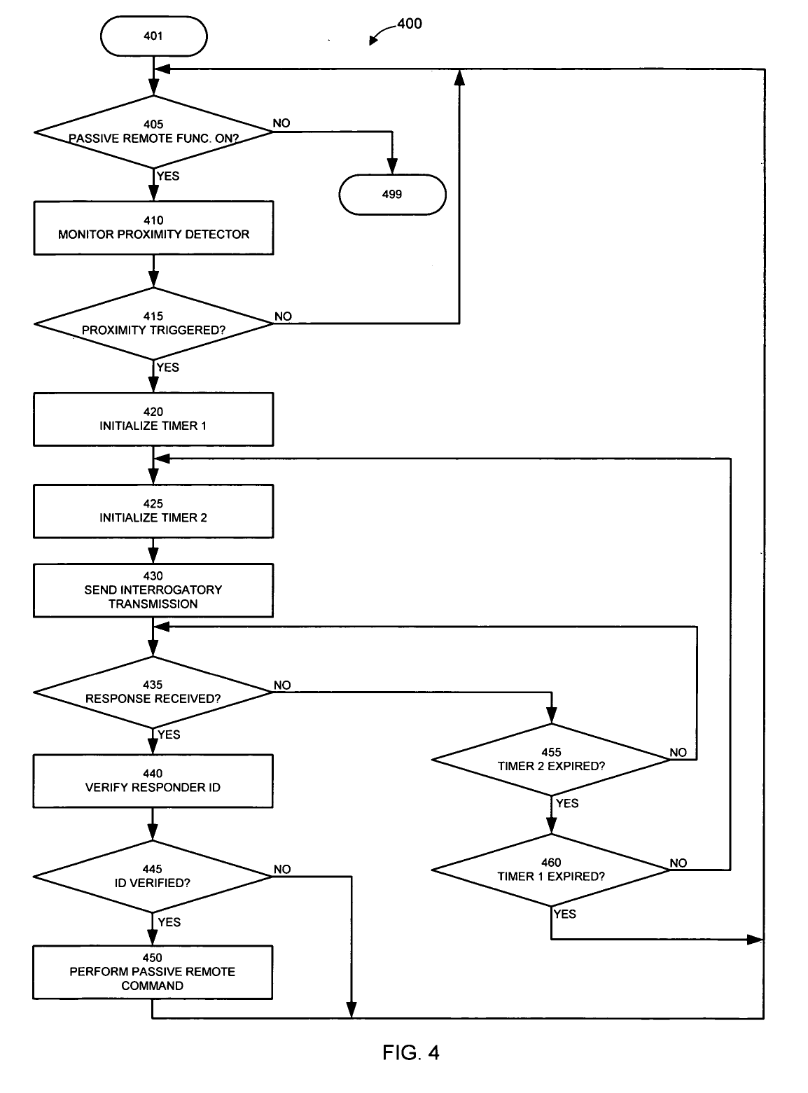

Let us now turn to aspects of the invention related to passive remote control functionality and related security features. FIG. 4 is a process flow diagram illustrating selected steps of a process 400 implementing passive remote capability enhanced through the use of the security system proximity detector. The process 400 may be performed by the security system illustrated in FIGS. 2 and 3. Although certain steps of the process are described serially, some of these steps can be performed by separate elements in conjunction or in parallel, asynchronously or synchronously, in a pipelined manner, or otherwise. There is no particular requirement that the steps be performed in the same order in which this description lists them, except where explicitly so indicated, otherwise made clear from the context, or inherently required. Furthermore, not every illustrated step is required in every embodiment in accordance with the invention, while some steps that have not been specifically illustrated may be desirable or necessary in some embodiments in accordance with the invention.

At flow point 401, the security system is in an armed state and configured to perform one or more commands when it determines that its user carrying a hand-held remote control device is within close range. For example, the security system may disarm itself, unlock doors of an automobile, and start the automobile's engine when the remote control device is near the automobile.

At decision block 405, the base station of the security system checks to determine whether passive remote control functionality is enabled. If the passive remote functionality is not enabled, the process terminates at flow point 499. If the functionality is enabled, the base station proceeds to monitor (e.g., read the output of) the proximity detector, at step 410.

At decision block 415, the security system determines whether the proximity detector output indicates movement of a person near the protected automobile. In the described embodiment, the security system compares the output of the proximity detector to a threshold corresponding to the passive remote feature. The passive remote feature threshold (“PR threshold”) may—but need not—be the same as the alarm threshold or the warn-away threshold. In one embodiment, the security system enables the user to set the PR threshold separately from the alarm and warn-away thresholds using a process such as the process 100 illustrated in FIG. 1.

Next, in steps 420 and 425, the security system initializes Timer 1 and Timer 2, respectively. The function of these timers will become clear from the following description.

At step 430, the base station of the security system transmits an interrogatory transmission. The interrogatory transmission triggers handshake transmissions between the base station and the hand-held remote control device so that the base station and the remote control device can verify each other's identity. When passive remote functionality is enabled, the base station may perform some predefined function upon a successful handshake. The function may be performed automatically by the base station. The function may also be triggered by an automatic command sent passively (without the user's direct involvement) from the remote control device. In other words, the specific automatic command(s) performed may be determined by the base station configuration, or by the configuration of the remote control device. In the latter case, the base station determines the specific command(s) from information carried by the transmissions from the remote control device made in response to the interrogatory transmissions.

From the step 430, process flow proceeds to decision block 435 to determine whether a response to the interrogatory transmission has been received. If the response has not been received, the base station determines, at decision block 455, whether Timer 2 has expired. If this timer has not expired, process flow returns to the decision block 435. Thus, the base station stays in the small loop formed by the decision blocks 435 and 455 (the inner loop) until it receives a response to one of the interrogatory transmissions, or until Timer 2 expires.

If the base station determines at the decision block 455 that Timer 2 has expired, it proceeds to decision block 460 to check whether Timer 1 has expired. If Timer 1 has not expired, process flow returns to the step 425 to reinitialize Timer 2. If Timer 1 has expired, process flow returns to the decision block 405 at the beginning of the process 400. Thus, the base station stays in the outer loop formed by the steps 425/430 and the decision blocks 435/455/460 until it receives a response to the interrogatory transmission or until Timer 1 expires. Generally, Timer 2 expires one or more times for each expiration of Timer 1.

If the base station determines at the decision block 435 that a response to the interrogatory transmission has been received, it proceeds to step 440 to verify identity of the responder device that sent the response, for example, to perform a handshake with the device.

At decision block 445, the base station determines whether the identification of the responder device was successful, i.e., whether the responder is an authorized remote control device.

If the responder device has been properly identified as an authorized device, the base station performs a passive remote command, at step 450. Process flow returns to the decision block 405 after the step 450, or if the base station is unable to determine that the responder is an authorized device.

In operation, the base station continuously monitors the output of its proximity detector. When the detector indicates that a person may be approaching the automobile, the base station sends an interrogatory transmission to the hand-held remote control device. In this way, the base station need not continually send out interrogatory transmissions, enhancing security, lowering power consumption, and eliminating unneeded electromagnetic emissions, thereby abiding by FCC regulations.

After the interrogatory transmission is sent, the base station attempts to receive a response. If a response is not received within a time period defined by Timer 2, the base station sends out another interrogatory transmission, and continues to do so until expiration of a time period defined by Timer 1. Because in some embodiments Timer 2 defines a shorter period than Timer 1, the base station may be able to make multiple interrogatory transmissions awaiting a response from the remote control device after the proximity detector is triggered. If no response is received within the Timer 1 period, the base station returns to monitoring the proximity detector. On the other hand, the base station performs a passive remote command (e.g., disarms the security system and unlocks automobile doors) if a response is received and the responder is verified as an authorized responder.

Note that the security system may also generate an alarm or a warn-away event when a person approaches the protected automobile. In some embodiments and for some relative values of the alarm, warn-away, and passive remote thresholds, the security system may generate an alarm or a warn-away event even as it is awaiting a response to the interrogatory transmissions, or while it is attempting to verify identity of the remote control device. The alarm or warn-away event may be suppressed upon successful identification of the device as an authorized device.

This document describes the inventive apparatus, methods, and articles of manufacture enhancing passive remote functionality and proximity detector calibration by end-users in considerable detail. This was done for illustration purposes only. Neither the specific embodiments of the invention as a whole, nor those of its features limit the general principles underlying the invention. The specific features described herein may be used in some embodiments, but not in others, without departure from the spirit and scope of the invention as set forth. Various physical arrangements of components and various step sequences also fall within the intended scope of the invention. Furthermore, the invention need not be limited to automotive or vehicular applications, but may extend to applications involving other kinds of security and convenience systems, and beyond. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is carried out by the claims and their equivalents.

What is claimed is:

1. A method of adjusting sensitivity of a proximity detector in a security system with a remote control device, the method comprising:
monitoring the detector to detect a security breach event;
receiving an indication from the remote control device signaling that the event has occurred; and
setting the sensitivity of the detector based on output of the detector corresponding to the event.

2. A method of adjusting sensitivity according to claim 1, further comprising:
identifying the event from the output of the detector immediately preceding receipt of the indication.

3. A method of adjusting sensitivity according to claim 2, wherein:
the step of setting comprises adjusting the sensitivity so that the detector is capable of responding to future security breach events substantially identical to the event.

4. A method of adjusting sensitivity according to claim 2, wherein:
the step of setting comprises adjusting the sensitivity so that the detector is capable of responding to future security breach events only with severity substantially no less than severity of the event.

5. A method of adjusting sensitivity according to claim 2, further comprising:
measuring a metric corresponding to the event within the output to obtain a first value;
wherein:
the step of setting comprises setting a threshold for the output metric of the detector to a number substantially equal to the value.

6. A method of adjusting sensitivity according to claim 5, wherein:
after the step of setting, the security system is capable of generating an alarm when the output metric violates the threshold.

7. A method of adjusting sensitivity according to claim 6, wherein:
the metric comprises signal amplitude.

8. A method of adjusting sensitivity according to claim 6, wherein:
the metric comprises signal frequency.

9. A method of adjusting sensitivity according to claim 2, wherein:
the proximity detector comprises a radio frequency (RF) transmitter; and
the step of setting comprises adjusting power level emitted by the RF transmitter.

10. A method of adjusting sensitivity of a proximity detector in a security system with a remote control device, the method comprising:
monitoring the detector to detect a plurality of security breach events;
receiving indications from the remote control device, each received indication signaling that an event from the plurality of events has occurred; and
setting the sensitivity of the detector based on output of the detector corresponding to the events.

11. A method of adjusting sensitivity according to claim 10, further comprising:
identifying each of the events from the output of the detector immediately preceding receipt of one of the indications.

12. A method of adjusting sensitivity according to claim 11, further comprising:
measuring a metric corresponding to the events within the output to obtain a plurality of values, each value of the plurality of values corresponding to a different one of the events;
wherein:
the step of setting comprises setting a threshold for the output metric of the detector to a number substantially equal to average of at least a subset of the plurality of values.

13. A method of adjusting sensitivity according to claim 12, wherein:
after the step of setting, the security system is capable of generating an alarm when the output metric violates the threshold.

14. A method of adjusting sensitivity according to claim 13, wherein:
the metric comprises signal amplitude.

15. A method of adjusting sensitivity according to claim 13, wherein:
the metric comprises signal frequency.

16. A security system according to claim 13, wherein:
the metric comprises signal amplitude integrated over time.

17. A method of adjusting sensitivity according to claim 11, wherein:
the proximity detector comprises a radio frequency (RF) transmitter; and
the step of setting comprises adjusting power level emitted by the RF transmitter.

18. An article of manufacture comprising machine-readable storage medium with program code stored in the medium, the program code, when executed by a security system controller, is capable of causing the controller to configure the security system to perform steps of the method of claim 1.

19. A security system comprising:
a base station comprising a proximity detector, a receiver, and a base controller coupled to the detector and to the receiver; and
a remote control device comprising user input device and a transmitter capable of sending information provided through the user input device to the receiver of the base station;
wherein the base controller is configured to cause the base station to perform steps comprising:
monitoring output of the detector to detect a security breach event;
receiving an indication from a remote control device signaling that the event has occurred;
identifying the event from the output immediately preceding receipt of the indication; and
setting sensitivity of the detector based on output of the detector corresponding to the event.

20. A security system according to claim 19, wherein the base controller is configured to cause the base station, in performing the step of setting, to adjust the sensitivity so that the detector is capable of responding to future security breach events substantially identical to the event.

21. A security system according to claim 20, wherein the base controller is configured to cause the base station, in performing the step of setting, to adjust the sensitivity so that the detector is capable of responding to future security breach events only with severity substantially no less than severity of the event.

22. A security system according to claim 19, wherein:
the base controller is further configured to cause the base station to measure a metric corresponding to the event within the output to obtain a value; and
the base controller is configured to cause the base station, in performing the step of setting, to set a threshold for the output metric of the detector to a number substantially equal to the value.

23. A security system according to claim 22, wherein the base controller is further configured to cause the base station to generate an alarm if the output metric violates the threshold after the step of setting.

24. A security system according to claim 23, wherein the metric comprises signal amplitude.

25. A security system according to claim 23, wherein the metric comprises signal frequency.

26. A security system according to claim 23, wherein the metric comprises signal amplitude integrated over time.

27. A method of adjusting sensitivity according to claim 19, wherein the proximity detector comprises a radio frequency (RF) transmitter.

28. A security system according to claim 27, wherein the base controller is further configured, in performing the step of setting, to cause the base station to adjust power level emitted by the RF transmitter.

29. A security system comprising:
a base station comprising a proximity detector, a receiver, and a base controller coupled to the detector and to the receiver; and
a remote control device comprising user input device and a transmitter capable of sending information provided through the user input device to the receiver of the base station;
wherein the base controller is configured to cause the base station to perform steps comprising:
monitoring output of the detector to detect a plurality of security breach events;
receiving indications from a remote control device, each received indication signaling that an event from the plurality of events has occurred;
identifying each of the events from the output immediately preceding receipt of one of the indications; and
setting the sensitivity of the detector based on output of the detector corresponding to the events.

30. A security system according to claim 29, wherein:
the base controller is configured to cause the base station to measure a metric corresponding to the events within the output to obtain a plurality of values, each value of the plurality of values corresponding to a different one of the events; and
the base controller is configured to cause the base station, in performing the step of setting, to set a threshold for the output metric of the detector to a number substantially equal to average of at least a subset of the plurality of values.

31. A security system according to claim 30, wherein the base controller is further configured to cause the base station to generate an alarm if the output metric violates the threshold after the step of setting.

32. A security system according to claim 31, wherein the metric comprises signal amplitude.

33. A security system according to claim 31, wherein the metric comprises signal frequency.

34. A security system according to claim 31, wherein the metric comprises signal amplitude integrated over time.

35. A security system according to claim 29, wherein the proximity detector comprises a radio frequency (RF) transmitter.

36. A security system according to claim 35, wherein the base controller is further configured, in performing the step of setting, to cause the base station to adjust power level emitted by the RF transmitter.

37. A method for operating a base station of a security system, the method comprising:
monitoring output of a proximity detector of the security system; and
sending an interrogatory transmission to a remote control device of the security system in response to an event detected by the proximity detector.

38. A method according to claim 37, further comprising:
receiving a response to the interrogatory transmission; and
determining whether the response was sent by a remote control device authorized to control the security system.

39. A method according to claim 38, further comprising:
passively performing at least one command by the base station in response to the step of determining resulting in a determination that the response was sent by a remote control device authorized to control the security system.

40. A method according to claim 39, wherein interrogatory transmissions are sent only in response to events detected by the proximity detector.

41. A method according to claim 39, wherein said at least one command comprises a command to unlock one or more doors of a vehicle.

42. A method according to claim 39, wherein said at least one command comprises a command to disarm the security system.

43. A method according to claim 39, wherein said at least one command comprises a command to start engine of a vehicle.

44. A base station of a security system, the base station comprising:
a transceiver;
a proximity detector providing an output signal; and
a controller configured to monitor the output signal of the proximity detector and cause the transceiver to send an interrogatory transmission to a remote control device of the security system in response to an event detected by the proximity detector.

45. A base station according to claim 44, wherein the controller is further configured to receive a response to the interrogatory transmission through the transceiver, and to determine whether the response was sent by a remote control device authorized to control the security system.

46. A base station according to claim 45, wherein the controller is further configured to perform at least one command when the controller determines that the response was sent by a remote control device authorized to control the security system.
